(19) United States
(12) Patent Application Publication
(10) Pub. No.: US 2024/0100985 A1
(43) Pub. Date: Mar. 28, 2024

(54) POWER PROCESSING SYSTEM

(71) Applicant: TOYOTA JIDOSHA KABUSHIKI KAISHA, Toyota-shi (JP)

(72) Inventor: Tohru NAKAMURA, Toyota-shi (JP)

(73) Assignee: TOYOTA JIDOSHA KABUSHIKI KAISHA, Toyota-shi (JP)

(21) Appl. No.: 18/358,503

(22) Filed: Jul. 25, 2023

(30) Foreign Application Priority Data
Sep. 26, 2022 (JP) 2022-152329

(51) Int. Cl. B60L 53/67; B60L 53/16; H02J 3/00; H02J 3/38

(52) U.S. Cl. CPC B60L 53/67; B60L 53/16; H02J 3/003; H02J 3/381; H02J 2300/24

(57) ABSTRACT

The power processing system includes a communication device and a processing device. The communication device is configured to communicate with both the facility and the management device. The processing device determines first power consumption, which is power consumption consumed in the facility during the aggregation period, among the power generation amounts of the renewable energy generated by the renewable energy power generation device during the predetermined aggregation period, and determines second power consumption, which is power consumption consumed in the facility, using normal power different from the renewable energy power. When the communication device receives the allocation request, the processing device executes the certificate issuance process.

### CROSS-REFERENCE TO RELATED APPLICATION

This application claims priority to Japanese Patent Application No. 2022-152329 filed on Sep. 26, 2022 incorporated herein by reference in its entirety.

### BACKGROUND

### 1. Technical Field

The present disclosure relates to a power processing system.

### 2. Description of Related Art

From the viewpoint of environmental protection, renewable energy such as sunlight has been attracting attention. Power consumers, such as businesses, may be possibly requested by governments or the like such that some or a whole of the power consumed in facilities of the power consumers are occupied by power derived from the renewable energy.

Japanese Unexamined Patent Application Publication No. 2020-9334 (JP 2020-9334 A) discloses a power trading platform. In this platform, power derived from photovoltaic power generation is traded between power consumers and generators. Such power has an environmental value in addition to the value of the power itself. The environmental value may be embodied as a certificate, such as a green power certificate, and traded. Power consumers can secure power derived from the photovoltaic power generation and its environmental value by trading through this platform.

### SUMMARY

Renewable energy power, such as power from the photovoltaic power generation, is generated by a renewable energy power generation device. Under the Feed in Tariff (FIT) system, power generated as described above has been purchased at fixed prices by power companies. After the termination of the FIT system, such renewable energy power is likely to be consumed in-house in a facility in which the renewable energy power generation device is installed. The self-consumption of renewable energy power is basically equivalent to meeting the power demand of the above-mentioned facility without CO2 emissions, thus contributing to the global environment.

A user of a facility different from the facility described above may consume power at the facility using normal power (e.g., power from the power grid) that is different from the renewable energy power. The user can satisfy a request from a government or the like by allocating the environmental value of the renewable energy power to the power consumption in the facility. As a result, the user can participate in an activity (environmental activity) for securing the environmental value. Such an activity is preferably promoted.

The present disclosure has been made in view of the above-described issue, and an object thereof is to provide a power processing system capable of promoting an environmental activity by a user of a facility different from a facility in which a renewable energy power generation device is installed in a case where renewable energy power is consumed in-house in the facility.

A power processing system according to the present disclosure includes: a communication unit; and a processing unit. The communication unit is configured to communicate with both a first facility in which a renewable energy power generation device is installed and a terminal device of a user of a second facility that is different from the first facility. The processing unit determines first power consumption (self-consumption of renewable energy power) that is electric energy consumed in the first facility during a predetermined aggregation period of a power generation amount of renewable energy power generated by the renewable energy power generation device during the aggregation period. The processing unit determines second power consumption that is electric energy consumed in a power consumption event implemented in the second facility, using normal power that is different from the renewable energy power. When the communication unit receives an allocation request from the terminal device, the processing unit executes a certificate issuance process.

The allocation request is a signal that requests allocation of at least a portion of an environmental value of the first power consumption to at least a portion of the second power consumption. The certificate issuance process is to issue a certificate certifying that at least a portion of the environmental value is allocated to at least a portion of the second power consumption.

With the above configuration, at least a portion of the environmental value of the first power consumption is allocated to at least a portion of the second power consumption through issuance of the certificate to the user of the second facility. As a result, the user of the second facility can be caused to secure the environmental value. Therefore, the environmental activity by the second user can be promoted when the renewable energy power is consumed in the first facility.

According to the present disclosure, when renewable energy power is consumed in the facility in which the renewable energy power generation device is installed, the environmental activity by the user of the facility different from the above facility can be promoted.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a power processing system according to an embodiment;

FIG. 2 is a diagram illustrating an apparatus installed in a facility;

FIG. 3 is a flowchart illustrating a process executed in connection with a certificate issuance process;

FIG. 4 is a diagram illustrating data stored in a storage device of a server;

FIG. 5 is a flowchart illustrating a process executed in Modification 1;

FIG. 6 is a flowchart illustrating a process performed by a server in connection with detecting a likelihood of fraud;

FIG. 7 is a diagram illustrating an overall configuration of a power processing system according to Modification 3;

FIG. 8 is a diagram illustrating data stored in a storage device;

FIG. 9 is a flowchart illustrating a process executed in Modification 3;

FIG. 10 is a flowchart illustrating a process executed in Modification 5.

### DETAILED DESCRIPTION OF EMBODIMENTS

Hereinafter, embodiments of the present disclosure will be described in detail with reference to the drawings. The same or corresponding parts in the drawings are denoted by the same reference numerals, and the description thereof will not be repeated. Each of the embodiments and the modification examples thereof may be combined with each other as appropriate.

### Embodiment

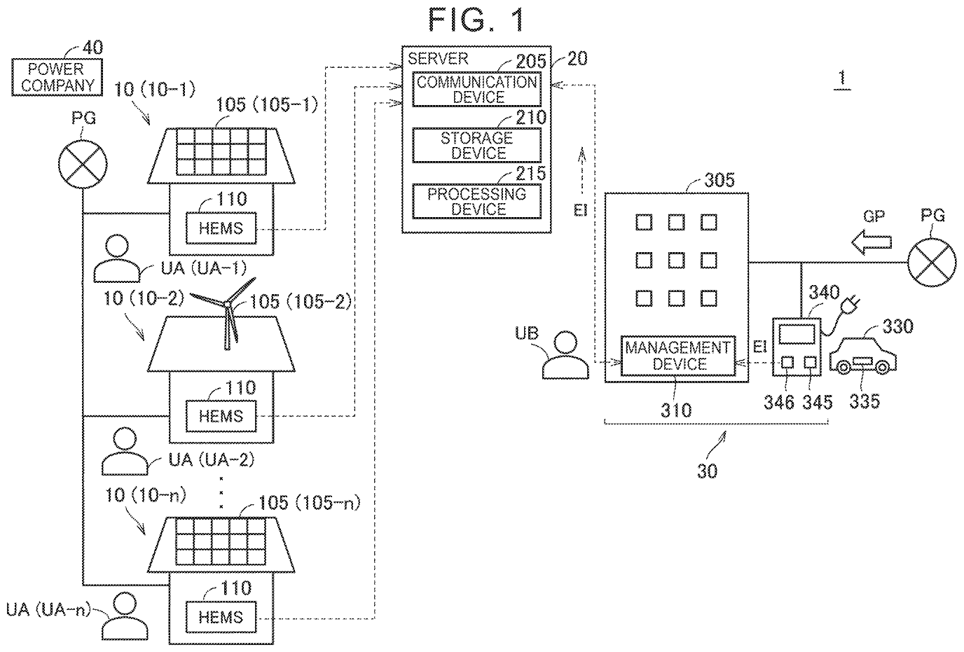

FIG. 1 is a diagram illustrating a configuration of a power processing system according to an embodiment. Referring to FIG. 1, the power processing system 1 includes a plurality of facilities 10, a server 20, and a facility 30.

The plurality of facilities 10 includes a facility 10-1, 10-2 . . . 10-n. Each user of the facility 10-1, 10-2 . . . 10n is also represented as a user UA-1, UA-2 . . . UA-n. Each of the user UA-1, UA-2 . . . UA-n is also represented as a user UA. The respective facilities 10 are connected to a power grid PG managed by the power companies 40.

In the respective facilities 10, a power generation device 105 and a Home Energy Management System (HEMS) 110 are installed.

The power generation device 105 generates electric power using renewable energy such as sunlight or wind power. The electric power generated by the power generation device 105 is also referred to as “renewable energy power” (green power). The power generation device 105 of the facility 10-1 is the photovoltaic power generation device 105-1. The power generation device 105 of the facility 10-2 is the wind power generation device 105-2. The power generation device 105 may be another type of renewable energy power generation device, such as a biomass generator or a geothermal generator.

HEMS 110 includes a processor, a memory, a secondary storage device, and an input/output interface (none of which are shown). The processor is, for example, a Central Processing Unit (CPU). The memories include Read Only Memory (ROM) and Random access memory (RAM). The input/output interface transmits and receives signals to and from various devices of the facility 10. The HEMS 110 manages the amount of electric power consumed by the facilities 10 and the amount of electric power generated by the power generation device 105.

The server 20 includes a communication device 205, a storage device 210, and a processing device 215. The communication device 205 is configured to communicate with both HEMS 110 of the respective facilities 10 and the management device 310 (described later) of the facilities 30. The communication device 205 corresponds to a “communication unit” of the present disclosure. The storage device 210 stores various data and information (described in detail later) used by the processing device 215. The processing device 215 includes a processor and a memory (none of which are shown). The processor is, for example, a CPU. The memories include ROM and RAM.

The facility 30 is owned by an enterprise (or individual) who is requested to participate in environmental activities to ensure environmental value. The facility 30 is scheduled to assign an environmental value to at least a portion of the amount of normal electricity consumed therein (a target facility for environmental activities). The normal power is a power that differs from the renewable energy power and, in this instance, is the grid power GP supplied from the power grid PG. The facility 30 is provided with a building 305 and a power facility 340.

The building 305 is connected to the power system PG. The building 305 is provided with a management device 310. The management device 310 is an exemplary terminal device of a user UB of the facility 30. The management device 310 determines, for example, the amount of power consumption in a power consumption event (also simply referred to as “power consumption event”) performed by the facility 30 using the normal power, or determines the type of the power consumption event.

The power facility 340 is connected to the power grid PG and is provided outside the vehicles 330. The power facility 340 includes a measurement device 345 and a communication device 346. The measurement device 345 measures power consumption in the facility 30 caused by external charging (described later) of the vehicle 330. The communication device 346 transmits the measurement value of the measurement device 345 and event information EI indicating the type of the power consumption event in the facility 30 to the management device 310. The event-information EI may be transmitted to the server 20 by the management device 310.

The vehicles 330 are electrified vehicle including the power storage device 335, and are owned by a user UB. The vehicle 330 is configured to be capable of performing external charging for charging the power storage device 335 of the vehicle 330 using the electric power supplied from the power facility 340. In this example, the external charging corresponds to a power consumption event in the facility 30.

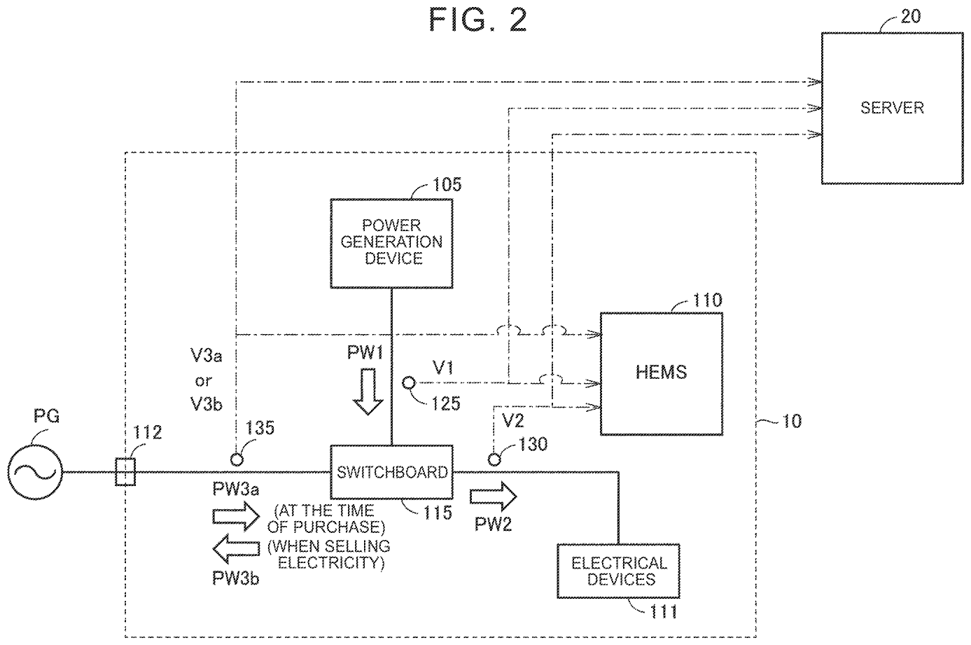

FIG. 2 is a diagram illustrating a device installed in the facility 10. Referring to FIG. 2, a power generation device 105, the HEMS 110, electric devices 111, a connecting portion 112, a switchboard 115, and a smart meter 125,130,135 are installed in the facility 10.

The power generation device 105 generates power PW1 using renewable energy. The electric devices 111 consume power PW2 in the facilities 10.

The switchboard 115 is connected to the power grid PG through the connecting portion 112. The switchboard 115 receives power PW1 from the power generation device 105 and supplies power PW2 to the electric devices 111. The power PW3a is grid power GP supplied to the facilities 10 (the switchboard 115) through the connecting portion 112, in other words, electric power purchased from the power companies 40 by the user UA. The power PW3b is electric power supplied from the facilities 10 to the power grid PG among the power PW1, in other words, electric power sold as renewable energy power to the power company 40 by the user UA (electric power purchased by the power company 40). The sum of the power PW1, PW3a is PW1+PW3a=PW2+PW3b equal to the sum of PW2, PW3b.

It is assumed that, during a period in which the user UA is buying from the power company 40 (a power buying period), it is difficult to cover the power demand in the facility 10 only by the power PW1, and all of the power PW1 are consumed by the facility 10 as a part of the power PW2 (consumed by the electric appliances 111). The sum of the power PW1, PW3a is then equal to the power PW2. On the other hand, during a period (electric power selling period) in which the user UA sells electric power to the power company 40, the electric power demand in the facility 10 can be covered only by the power PW1, and the power PW2 in the power PW1 is consumed by the facility 10. The power PW1 is then equal to the sum of the power PW2, PW3b.

The smart meter 125,130,135 measures power PW1, PW2, PW3a and PW3b, respectively. The measured value of the power PW1, PW2, PW3a, PW3b is a measured value V1, V2, V3a, V3b. Each of the smart meters 125,130,135 sequentially transmits the corresponding readings to the server 20 along with the site Identification (ID). These measures may be sent to HEMS 110. The facility ID data indicates ID of the facility 10 allocated in advance, and is stored in a memory (not shown) of the smart meter 125,130,135.

Under the Feed in Tariff (FIT) scheme, renewable energy power generated by the power generation device 105 has been bought by the power company 40 at a fixed price. After completion of FIT system, it is considered that the renewable energy power generated in this way is more likely to be consumed by the facilities 10 (more likely to be consumed by the electric appliances 111) than is sold to the power companies 40. The in-house consumption of renewable energy power in the facility 10 basically corresponds to the supply of electric power in the facility 10 without CO2 emission, and contributes to CO2 reduction (environmental protection). The user UA making such a contribution is preferably evaluated in some way.

The user UB of the facility 30 may wish to assign the environmental value of the renewable energy power to the amount of power consumed in the power consumption event at the facility 30 (in this instance, external charging) in order to perform the aforementioned environmental activities. Such environmental activities are preferably promoted.

The inventors have noticed that setting an environmental value to the in-house consumption of renewable energy power in the facility 10 leads to an assessment of user UA for reducing CO2 caused by the in-house consumption of renewable energy power. Furthermore, the inventors have noticed that assigning the environmental value thus set to the power consumption event in the facility 30 leads to the promotion of the environmental activity by the user UB.

In the embodiment, the server 20 executes the following first determination processing, second determination processing, request reception processing, and certificate issuance processing.

The first determination process is to determine the amount of electric power consumed in the facility 10 during the aggregation period from the amount of electric power generated by the renewable energy power generated by the power generation device 105 during the predetermined aggregation period. This amount of electric power is also referred to as “first power consumption”. The above-described aggregation period is a period in which the result of the electric power use in the facility 10 over this period is aggregated (a billing period of the electric power charge for the facility 10), and is, for example, one day, one week, or one month. Since the first power consumption is the in-house consumption of the renewable energy power during the aggregation period, it is considered to have an environmental value. In this embodiment, it is assumed that a whole of the first power consumption have an environmental value. A case where only a part of the first power consumption has an environmental value will be described in Modification 1.

During purchasing, all of the power PW1 is consumed by the facilities 10 as part of the power PW2. On the other hand, during the electric power selling, the power PW2 of the power PW1 is consumed in-house. Therefore, the first power consumption is the sum of the time integrated value (first integrated value) of the power PW1 during the power buying period in the aggregation period and the time integrated value (second integrated value) of the power PW2 during the power selling period in the aggregation period. The server 20 sequentially determines the power buying period and the power selling period in the facilities 10 according to the measured-value V3a, V3b. According to the result of the determination and the measured value V1, V2, the server 20 sequentially calculates the time integrated value of the power PW1 during the power purchase period and the time integrated value of the power PW2 during the power selling period, and stores the result of the calculation in the storage device 210. Then, after the end of the aggregation period, the first integrated value and the second integrated value are determined, and the first power consumption is determined.

In the second determination process, the amount of electric power consumed in the electric power consumption event (external charging) in the facility 30 is determined. This amount of electric power is also referred to as “second power consumption”. The second power consumption is, in this example, the power consumption at the facility 30 due to external charging, and is determined according to the measurement value of the measurement device 345 of the power facility 340.

The request reception process is to receive an allocation request from the management devices 310. The allocation request is a signal requesting to allocate at least a part of the environmental value (in-house consumption environmental value) of the first power consumption to at least a part of the second power consumption. The allocation request includes information indicating an environmental value (required environmental value) required to be allocated to the second power consumption. The required environmental value corresponds to at least a part of the environmental value of in-house consumption. The allocation request is generated by the management device 310 and transmitted from the management device 310 to the server 20. If the allocation request requires that all of the second power consumption be assigned an environmental value, the power consumption event at the facility 30 is treated as a CO2 free event.

The in-house consumption environmental value is set by the server 20 in accordance with the first power consumption and the environmental value (unit environmental value) per unit power consumption (for example, the higher the first power consumption management device is set). In this example, the unit environmental value is represented by a default value stored in the storage device 210, which is appropriately determined in advance by the administrator of the server 20.

The certificate issuance process is executed when the communication device 205 receives an allocation request from the management device 310. The certificate issuance process is to issue a certificate (renewable energy certificate) certifying that the requested environmental value has been assigned to the second power consumption.

When the first determination process, the second determination process, the request reception process, and the certificate issuance process are executed as described above, the requested environmental value is allocated to the second power consumption through issuance of the certificate to the user UB of the facility 30. Consequently, the user UB can secure the environmental value. Therefore, the environmental activity by the user UB can be promoted.

The server 20 collects the measurements from the smart meters 125,130,135 of each of the plurality of facilities 10 and determines the first power consumption of each facility 10 during the aggregation period. The server 20 sets the environmental value of each item of the first power consumption according to the corresponding first power consumption. The server 20 calculates the sum of each of these environmental values as the total environmental value, and stores the calculation result as the total environmental value information in the storage device 210. The allocation request is also a signal requesting that at least a part of the environmental value of the total environmental value be assigned to the second power consumption as the required environmental value. Since the total environmental value is derived from the environmental value of the in-house consumption in the facility 10, at least a part of the total environmental value is assumed to include the environmental value of the in-house consumption.

By calculating the total environmental value by setting the in-house consumption environmental value in each facility 10, it is possible to more easily collect the environmental value from each facility 10. Accordingly, even when the required environmental value is large, it is possible to easily avoid a situation in which the environmental value derived from the private consumption of the renewable energy power is insufficient and the required environmental value cannot be allocated to the second power consumption. Consequently, environmental activities by the user UB can be more effectively promoted.

The certificates are sold to the user UB at prices that depend on the required environmental value. For example, the higher the required environmental value, the higher the selling price of the certificate. At least a part of the profit (sales profit) obtained by the sale of the certificate is provided to the user UA (distributed to the respective user UA) as a reward for the self-consumption of the renewable energy power. This reward is set according to the first power consumption (for example, the larger the first power consumption, the larger the reward amount).

When a reward is provided to the user UA in this manner, the user UA can be evaluated in the form of a reward for reducing CO2 caused by the self-consumption of the renewable energy power in the facilities 10.

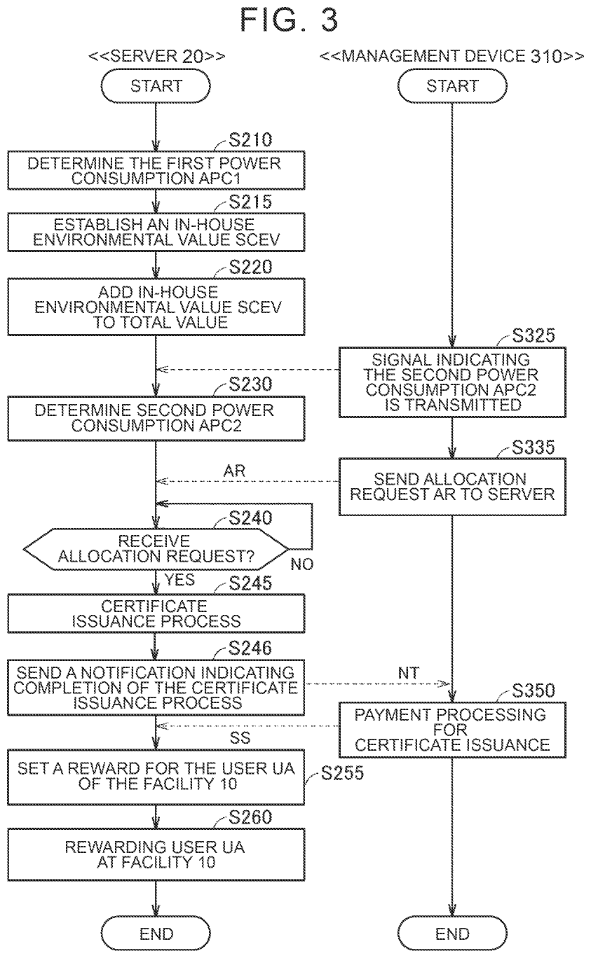

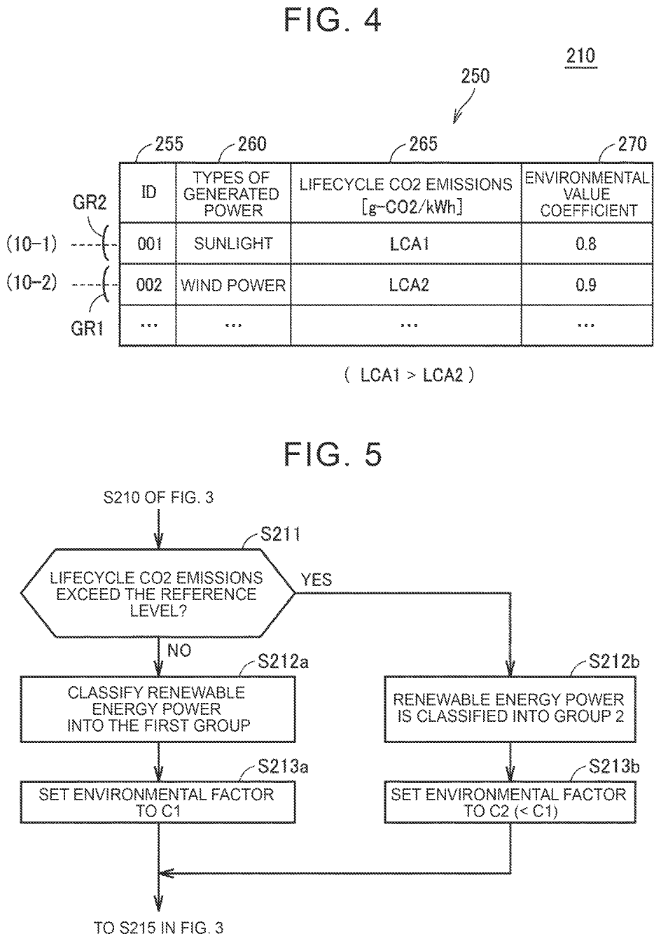

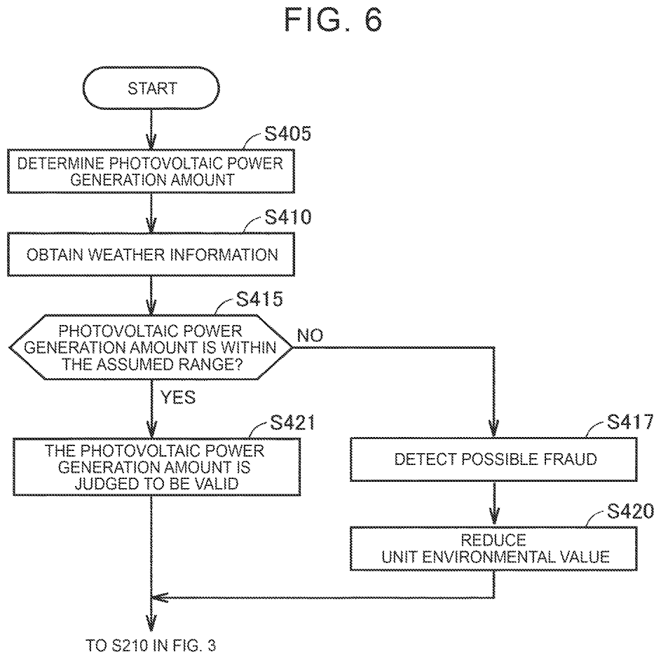

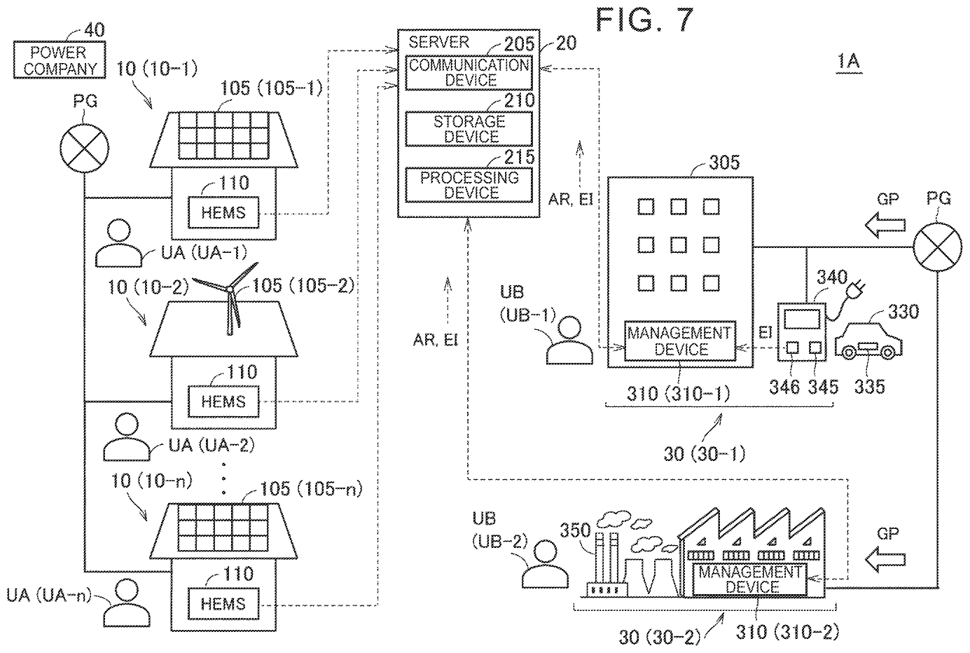

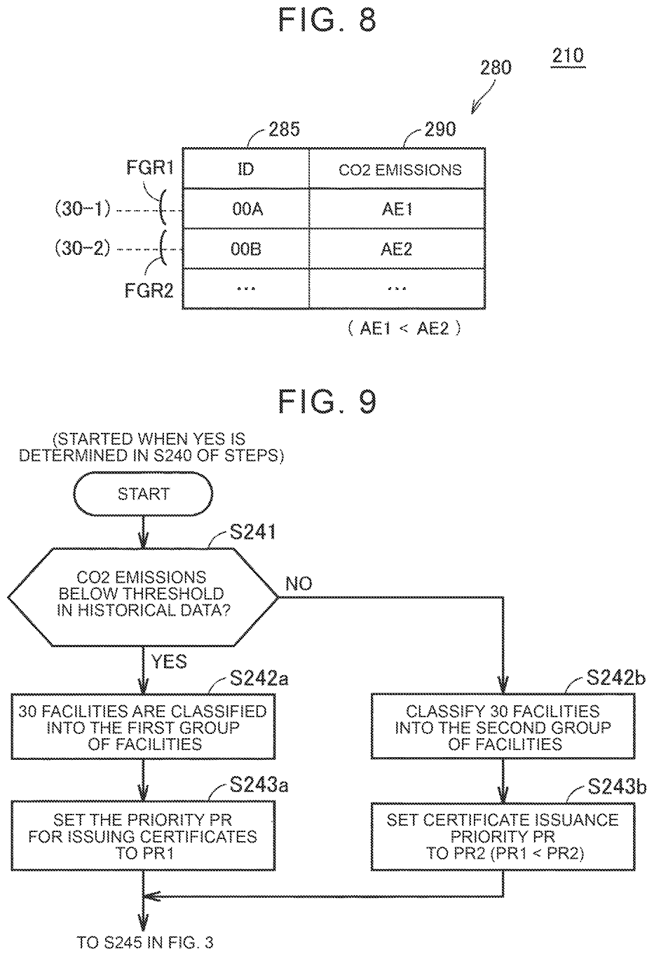

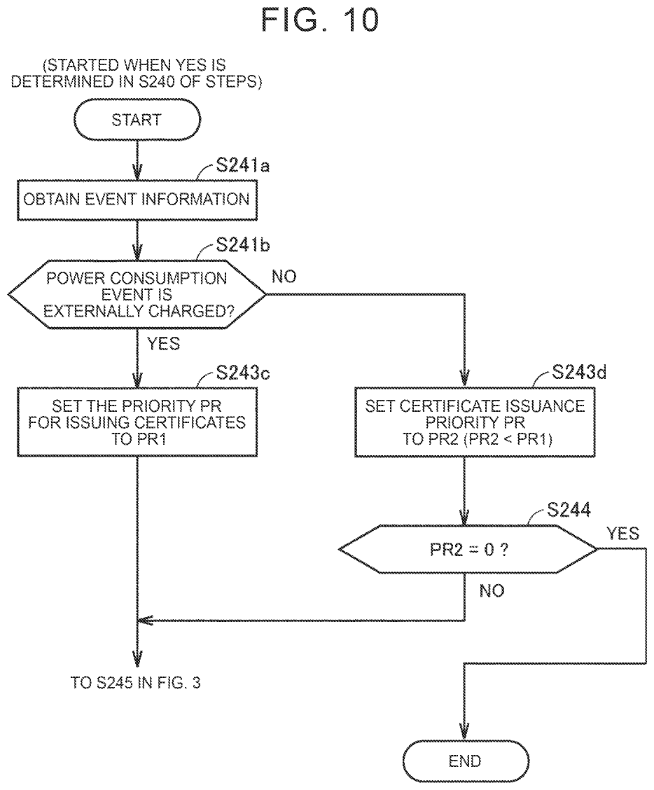

FIG. 3 is a flowchart illustrating a process executed in association with the certificate issuance process. This flowchart is started every time the above-described aggregation period ends. Prior to the beginning of this flow chart, it is assumed that the user UA, UB are registered in the server 20 as users who wish to sell and buy environmental values, respectively. Hereinafter, the step is abbreviated as “S”.

Referring to FIG. 3, the server 20 determines the first power consumption APC1 according to the first integrated value and the second integrated value (S210).

The server 20 sets the in-house consumption environmental value SCEV according to the first power consumption APC1 and the unit environmental value (S215). The server 20 adds the set in-house consumer environmental value SCEV to the total environmental value, and updates the total environmental value (S220).

The management device 310 of the facility 30 transmits a signal indicating the second power consumption APC2 to the server 20 (S325), and then transmits an allocation request AR to the server 20 (S335).

The server 20 determines the second power consumption APC2 in accordance with the above-described signal (S230), and determines whether or not the allocation request AR has been received (S240). If the allocation request AR has not been received yet (in S240, NO), the server 20 continues S240 determination process until the allocation request AR is received. When the allocation request AR is received (YES in S240), the server 20 executes a certificate issuance process (S245), and then transmits notification NT indicating completion of the certificate issuance process to the management device 310 (S246).

In response to receiving the notification NT, the management device 310 executes a payment process for issuing a certificate (S350). As a result, payment from the user UB to the administrator of the server 20 is executed. The management device 310 transmits a signal SS indicating completion of the payment process to the server 20.

Upon receiving the signal SS, the server 20 sets a reward for the user UA of the facility 10 in accordance with the first power consumption APC1 (S250). Thereafter, the server 20 executes a process (for example, a payment process) for providing a reward to the user UA (S260).

In the above description, S325, S335, S350 process is executed every time the above-described aggregation period ends, but may be executed every time the power consumption event in the facility 30 is executed. That is, S350 payment process may be executed each time a power consumption event is executed (payment for each certificate issuance). For each payment, the server 20 may prohibit the issuance of a certificate to the user UB when the requested environmental value from the facility 30 reaches a predetermined upper limit value (when the payment fee reaches the upper limit fee) (the issuance of a certificate under the fixed-amount system).

As described above, according to the present embodiment, it is possible to quantitatively evaluate the user UA in the form of the reward for the environmental contribution (CO2 reduction) achieved by the private consumption of the renewable energy power, and to promote the environmental activity by the user UB.

### First Modification

The server 20 may set (change) the in-house consumed environmental value SCEV according to the type of the power generation device 105 (specifically, whether the power generation device 105 corresponds to the photovoltaic power generation device 105-1, the wind power generation device 105-2, the biomass power generation device, the geothermal power generation device, or the like).

Specifically, the server 20 sets the in-house consumed environmental value SCEV according to the lifecycle CO2 emissions of the power generation device 105. Lifecycle CO2 emissions are expressed as CO2 emissions per unit of power generation of renewable energy power that reflect CO2 emissions in a series of processes, including manufacturing, operating, and disposing of the power generation device 105. CO2 emissions in the above-described series of processes include the amounts of CO2 discharged from the plant when the power generation device 105 is manufactured.

FIG. 4 is a diagram illustrating data stored in the storage device 210 of the server 20. Referring to FIG. 4, the lifecycle CO2 data 250 includes ID information 255, type information 260, lifecycle CO2 emissions information 265, and factor information 270.

ID data 255 indicates ID of the facility 10 for each facility 10. In this case, the facilities 10 having 001 and 002 ID correspond to the facilities 10-1 and 10-2, respectively. The type information 260 indicates the type of power generated by the corresponding power generation device 105 for each facility 10.

The lifecycle CO2 emissions data 265 indicates lifecycle CO2 emissions (g/kWh) of the corresponding power generation device 105. The lifecycle CO2 emissions of the wind power generation device 105-2 are smaller than the lifecycle CO2 emissions of the photovoltaic power generation device 105-1.

The coefficient data 270 indicates a coefficient (environmental coefficient) used for setting the in-house consumed environmental value SCEV. The environmental factor is used to determine a percentage of the power consumption having an environmental value of the first power consumption APC1, and is greater than 0 and less than 1. In other words, in the first modification, only the product of the first power consumption APC1 and the environmental factor among APC1 of the first power consumption is treated as having an environmental value. The server 20 sets the in-house consumed environmental value SCEV according to the multiplication value of the product and the unit environmental value.

In this example, for the facility 10-1, only 80% of the electric power generated by the photovoltaic power generation device 105-1 is treated as having environmental value. For facility 10-2, only 90% of the electricity generated by wind power generation device 105-2 is treated as having environmental value.

The server 20 executes a classification process (first classification process) of classifying the renewable energy power into the first group GR1 or the second group GR2 in accordance with the lifecycle CO2 emissions of the power generation device 105. If the renewable energy power is classified as a first group GR1, there are less lifecycle CO2 emissions than if the renewable energy power is classified as a second group GR2. In this embodiment, the server 20 classifies the electric power derived from the wind power generation into the first group GR1, and classifies the electric power derived from the photovoltaic power generation into the second group GR2.

The server 20 executes a value setting process of setting the in-house environmental value SCEV according to the first classification process. This value setting process is to set the in-house consumed environmental value SCEV higher than when the renewable energy power is classified in the first group GR1 than when the renewable energy power is classified in the second group GR2 (in this example, including setting the environmental coefficient for the facility 10-2 higher than the environmental coefficient for the facility 10-1).

When the above value setting process is executed, the lifecycle CO2 emissions are reflected in the in-house consumed environmental value SCEV. Specifically, when the lifecycle CO2 emissions are small, the in-house consumed environmental value SCEV is set higher than when the lifecycle CO2 emissions are large.

FIG. 5 is a flowchart illustrating a process executed in the first modification. This flow chart is started when S210 of FIG. 3 ends.

Referring to FIG. 5, the server 20 determines whether or not the lifecycle CO2 emissions of the power generation device 105 of the facility 10 are equal to or greater than the reference amount in accordance with the facility ID information and the lifecycle CO2 data 250 (S211). The reference amount is determined in advance as appropriate by experimentation as an environmentally particularly preferable amount in which the lifecycle CO2 emissions are less than the reference amount.

If the lifecycle CO2 emissions are less than the reference (NO in S211), the server 20 classifies the renewable energy power into a first group GR1 (S212a) and set the environmental factor to C1 (S213a). On the other hand, when the lifecycle CO2 emissions are equal to or greater than the reference amount (YES in S211), the server 20 classifies the renewable energy power into the second group GR2 (S212b) and sets the environmental factor to C2 (<C1) (S213b). After S213a or S213b, in S215 (FIG. 3), the server 20 sets the in-house consumed environmental value SCEV according to the environmental factors.

According to the first modification, the lifecycle CO2 emissions are reflected in the in-house consumed environmental value SCEV. Consequently, in-house consumer environmental value SCEV can be set in a more realistic way.

### Second Modification

As described above, the user UA can obtain a larger reward as the first power consumption APC1 increases. On the other hand, if the user UA attempts to increase this reward by fraud (for example, if the photovoltaic power generation device 105-1 is replaced with another power source to illegally increase the power PW1 and the first power consumption APC1), the reliability of the in-house consumption environmental value SCEV decreases. This leads to a decrease in the reliability of the total environmental value derived from the in-house consumption environmental value SCEV and the reliability (reliability of the certificate) of the environmental value allocated to the second power consumption APC2 based on the total environmental value.

In Modification 2, the communication device 205 of the server 20 acquires weather information indicating the weather during the aggregation period in the area where the facility 10-1 in which the photovoltaic power generation device 105-1 is installed is located from the external server. The processing device 215 of the server 20 determines the photovoltaic power generation device that is the power generation amount of the renewable energy power generated by the photovoltaic power generation device 105-1 during the aggregation period, and determines whether the photovoltaic power generation amount is within the assumed range according to the photovoltaic power generation amount and the weather information. The assumed range is appropriately determined in advance by experiment as a realistic range of the photovoltaic power generation amount during the aggregation period.

When the photovoltaic power generation amount is outside the assumed range, the server 20 detects the possibility of the fraud by the user UA-1, and reduces SCEV of the environmental value of the in-house consumption by lowering the environmental value of the units from the default value than when the photovoltaic power generation amount is within the assumed range. Accordingly, it is possible to prevent an unreasonable increase in the environmental value SCEV for personal use.

FIG. 6 is a flowchart illustrating a process executed by the server 20 in connection with detection of a possibility of fraud. This flowchart is started every time the above-described aggregation period ends, and is executed before the start of the flowchart of FIG. 3.

Referring to FIG. 6, the server 20 determines the photovoltaic power generation amount during the aggregation period (S405), acquire weather information during the aggregation period in the area where the facilities 10-1 are located (S410), and determine whether the photovoltaic power generation amount is within an assumed range (S415). When the photovoltaic power generation amount is outside the assumed range (NO in S415), the server 20 detects the possibility of fraud by the user UA-1 (S417), and lowers the environmental value of units from the default value (S420). Otherwise (YES in S415), the server 20 determines that the photovoltaic power generation amount is valid (S421). After S420 or S421, the process proceeds to S210 of FIG. 3.

According to the second modification, it is possible to prevent a decrease in the reliability of the total environmental value derived from the in-house consumed environmental value SCEV. Consequently, it is possible to prevent a decrease in the reliability of the environmental value (the reliability of the certificate) allocated to the second power consumption APC2.

### Third Modification

In the third modification, the server 20 stores a history of CO2 emissions from the facilities of the enterprise requested to participate in the environmental activity, and execute the certificate issuance process according to the history.

FIG. 7 is a diagram illustrating an overall configuration of a power processing system according to a third modification. Referring to FIG. 7, the facility 30 including the building 305 is also represented as the facility 30-1 in the power processing system 1A. The user UB and the management device 310 of the facility 30-1 are also represented as a user UB-1 and a management device 310-1, respectively. The power processing system 1A differs from the power processing system 1 (FIG. 1) in that it further comprises a facility 30 (30-2) comprising a flue gas device 350.

The facility 30-2 is connected to the power grid PG and is a target facility for environmental activities. The facility 30-2 is a factory where the flue gas device 350 discharges many CO2. The power consumption event in the facility 30-2 is an event different from the external charging of the vehicle 330 (for example, a power consumption event for operating a production line of a factory). The user UB and the management device 310 of the facility 30-2 are also represented by the user UB-2 and the management device 310-2, respectively.

Similarly to the management apparatus 310-1, the management apparatus 310-2 is configured to be capable of transmitting allocation request AR to the server 20. When the management device 310-2 transmits the allocation request AR to the server 20, a part of the total environmental value may be allocated to the power consumption event in the facility 30-2. The management device 310-2 also transmits event information EI indicating the type of the power consumption event in the facility 30-2 to the server 20.

FIG. 8 is a diagram illustrating data stored in the storage device 210. Referring to FIG. 8, the history data 280 includes ID information 285 and CO2 emission history information 290.

ID data 285 indicates ID of the target facilities of the environmental activity. In this case, facilities with ID of 00A and 00B correspond to facilities 30-1 and 30-2, respectively. CO2 emission amount history data 290 indicates a history of CO2 emissions from the facilities having the corresponding ID in a predetermined period (e.g., one year). In this history, CO2 emissions from facilities 30-1 and 30-2 are emissions AE1, AE2 (AE1<AE2), respectively.

The server 20 executes a classification process (second classification process) of classifying the facility 30 into the first facility group FGR1 or the second facility group FGR2 in accordance with the history data 280. When the facility 30 is classified into the first facility group FGR1, CO2 emission is smaller in the history data 280 than when the facility 30 is classified into the second facility group FGR2.

When the facility 30 is classified into the first facility group FGR1, the server 20 issues certificates preferentially over when the facility 30 is classified into the second facility group FGR2. Specifically, the server 20 sets the priority (0 or more) for the user UB of the facility 30 in accordance with the outcome of the second classification process, and executes the certificate issuance process in accordance with the priority.

For example, when the facility 30 is classified into the first facility group FGR1 (which is the facility 30-1), the server 20 sets the priority of issuing the certificate for the user UB to the first priority. On the other hand, when the facility 30 is classified into the second facility group FGR2 (which is the facility 30-2), the server 20 sets the priority of issuing the certificate for the user UB to the second priority. The first priority is higher than the second priority. When the priority is the first priority, the server 20 issues the certificate preferentially over when the priority is the second priority.

The issuing of the certificate preferentially when the facility 30 is classified into the first facility group FGR1 includes, for example, the server 20 receiving the allocation request AR from each of the facilities 30-1 and 30-2, and issuing only the certificate for the user UB-1 of the facility 30-1 associated with the first priority when the total environmental value is insufficient. The lack of the total environmental value means that, for example, the sum of the required environmental values included in the allocation request AR is larger than the total environmental value, and the respective required environmental values are less than the total environmental value (that is, only one of the required environmental values can be allocated to the corresponding second power consumption APC2).

When the certificate issuance process is executed in accordance with the outcome of the second classification process as described above, the certificate is issued preferentially when CO2 emissions from the facilities 30 are small, than when CO2 emissions are large. This facilitates issuance of certificates to facilities 30 (facilities 30-1) with low CO2 emissions. Consequently, environmental activities by the user UB-1 can be facilitated. On the other hand, environmental activities by the user UB-2 become difficult. As a consequence, it is possible to avoid a situation that contradicts the fact that companies with 30-2 facilities are recognized by the public as contributing to environmental conservation through environmental activities, and that these companies emit a lot of CO2.

FIG. 9 is a flowchart illustrating a process executed in Modification 3. This flow chart is started when a YES determination is made in S240 of FIG. 3.

Referring to FIG. 9, the server 20 determines whether CO2 emission amount in the history data 280 is less than the threshold amount (S241). The threshold amount is determined experimentally as an environmentally favorable amount in which CO2 emission amount in a predetermined period is less than the threshold amount.

If CO2 emission is less than the threshold (YES in S241), the server 20 classifies the facility 30 into the first facility group FGR1 (S242a), and sets the priority PR of the certificate issuance for the user UB of the facility 30 (30-1) to the first priority PR1 (S243a). On the other hand, when CO2 emission amount is equal to or larger than the threshold amount (NO in S241), the server 20 classifies the facility 30 into the second facility group FGR2 (S242b), and sets the priority PR of the certificate issuance for the user UB of the facility 30 (30-2) to the second priority PR2 (S243b). After S243a or S243b, the process proceeds to S245.

In S245, the server 20 executes the certificate issuance process in accordance with the priorities PR. For example, when the priority PR is set to the first priority PR1, the certificate for the user UB of the facility 30 is issued regardless of the shortage of the total environmental value. On the other hand, when the priority PR is set to the second priority PR2 and the total environmental value is insufficient, the issuance of the certificate to the user UB of the facility 30 is postponed until the shortage of the total environmental value is resolved.

According to the third modification, the environmental activity by the user UB-1 can be easily performed. Consequently, the user UB-1 can be further encouraged to reduce CO2 emissions.

### Modification 4

When the facility 30 is classified into the first facility group FGR1, the server 20 may set the sales prices of the certificates to the user UB lower than when the facility 30 is classified into the second facility group FGR2. For example, when the required environmental value included in the allocation request AR from the facilities 30-1 and 30-2 is the same, the server 20 may set the selling price of the certificate to the user UB-1 lower than the selling price of the certificate to the user UB-2.

When the selling price is set as described above, when the actual CO2 emission amount is small, the user UB can buy the certificate at a lower price than when CO2 emission amount is large. For example, a user UB-1 may buy a certificate at a lower cost than a user UB-2. Consequently, it is possible to further encourage the user UB-1 to reduce CO2 emissions in the facilities 10-1.

### Modification 5

In Modification 5, the server 20 (the communication device 205) acquires, from the management device 310, event information EI indicating the type of the power consumption event in the facility 30. The event information indicates whether the power consumption event is external charging of the vehicle 330. The server 20 (the processing device 215) executes the certificate issuance processing in accordance with the event-information EI. For example, when the power consumption event in the facility 30 is external charging, the server 20 preferentially issues a certificate for the user UB of the facility 30 than when the power consumption event is not external charging.

In this example, if external charging is performed at the facility 30 (if the facility 30 is facility 30-1), the server 20 prioritizes the issuance of certificates to the user UB of the facility 30 to the first priority. On the other hand, when a power consumption event different from an external charging is implemented in the facility 30 (when the facility 30 is a facility 30-2), the server 20 sets the priority of issuing a certificate to the user UB of the facility 30 to the second priority (e.g., 0). The first priority is higher than the second priority. When the priority is set to 0, issuance of a certificate is prohibited.

Issuing the certificate preferentially when external charging is performed at the facility 30 includes, for example, the server 20 receiving the allocation request AR from each of the facilities 30-1 and 30-2, and issuing only the certificate for the user UB-1 of the facility 30-1 related to the first priority when the total environmental value is insufficient. That is, the certificate issuance process corresponds to issuing a certificate to the user UB (i.e., to the user UB-1 only) only when the power consumption event is external charging. The server 20 may preferentially issue the certificate to the user UB-1 by setting the second priority for the user UB-2 to 0 and prohibiting the issuance of the certificate to the user UB-2.

When the certificate issuance process is executed according to the event-information EI as described above, the certificate is issued to the user UB-1 preferentially over the user UB-2. Consequently, environmental activities by the user UB-1 can be facilitated. In particular, it is effective to set the second priority to 0. This prohibits the issuance of certificates to the user UB-2 and only entities that own externally chargeable electrified vehicle, such as user UB-1, are issued certificates. Consequently, for example, if the user UB-1 owns a gasoline vehicle (not shown) in addition to the vehicle 330, the user UB-1 may be motivated to replace the gasoline vehicle with an externally chargeable electrified vehicle to more easily perform environmental activities. Therefore, it is possible to contribute to the popularization of electrified vehicle.

FIG. 10 is a flowchart illustrating a process executed in Modification 5. This flow chart is started when a YES determination is made in S240 of FIG. 3.

Referring to FIG. 10, the server 20 acquires event-information EI from the facilities 30 (S241a). The server 20 determines whether or not the power consumption event in the facilities 30 is external charging in accordance with the event information EI (S241b).

If the power consumption event is external charging (YES in S241b), in this example, if the source of the allocation-request AR is the facility 30-1, the server 20 sets the priority PR of the certificate issuance for the user UB-1 to the first priority PR1 (S243c). Thereafter, the process proceeds to S245 of FIG. 3. In S245, as in the case of the third modification, the server 20 executes the certificate issuance process according to the priorities PR.

On the other hand, when the power consumption event is not external charging (NO in S241b), in this example, when the source of the allocation request AR is the facility 30-2, the server 20 sets the priority PR of the certificate issuance to the user UB-2 to the second priority PR2 (S243d).

The server 20 switches the process according to whether the second priority PR2 is 0 (S244). If the second priority PR2 is not 0 (NO in S244), the process proceeds to S245. When the second priority PR2 is 0 (YES in S244), the server 20 prohibits issuance of the certificate, and ends the process.

When the power consumption event in the facility 30-1 includes the external charging and a power consumption event (for example, the operation of the air conditioner installed in the building 305 of the facility 30-1) different from the external charging, the management device 310-1 may transmit, as the second power consumption APC2, only the power consumption in the external charging out of the total power consumption in the event and the external charging to the server 20.

### Modification 6

According to Modification 5, since it is possible to contribute to the popularization of electrified vehicle, it is possible to contribute to CO2 reduction.

The server 20 may set the selling prices of the credentials to the user UB lower than otherwise if the power consumption event at the facility 30 is external charging. For example, when the required environmental value included in the allocation request AR from the facilities 30-1 and 30-2 is the same, the server 20 may set the selling price of the certificate to the user UB-1 lower than the selling price of the certificate to the user UB-2.

When the selling price is set as described above, the user UB can buy the certificate at a lower price than otherwise when external charging is performed at the facility 30. For example, a user UB-1 may buy a certificate at a lower cost than a user UB-2 (environmental activities may be easily performed). Consequently, the user UB-1 can be motivated to replace the gasoline-powered vehicle with an electrified vehicle, as described above.

### Other Modifications

The facility 10 may further include a power storage device for storing renewable energy generated by the power generation device 105, and a smart meter for a power storage device that measures charging power or discharging power of the power storage device during the aggregation period. Here, the first power consumption is determined according to the measured value of the smart meter and the power PW1, PW2, PW3a, PW3b.

Normally, the power is not limited to grid power GP. For example, when a cogeneration system that generates electric power using gas used in the facility 10 is installed in the facility 10, the normal electric power may be the electric power generated by the system.

The server 20 may issue a certificate indicating the in-house consumption environmental value SCEV (in-house consumption value certificate) to the user UA. This certificate is issued for each of the facilities 10 and is purchased from the respective user UA by the administrator of the server 20. Then, the server 20 may calculate the sum of the in-house consumer environmental value SCEV of the plurality of purchased certificates as the total environmental value.

From S210 of FIG. 3, a part of S255 (for example, the process of determining the first power consumption in S212) may be executed by HEMS 110 instead of the server 20. Therefore, the “processing unit” of the present disclosure is a concept including the processing device 215 and HEMS 110.

All of S255 from S210 may be executed by HEMS 110 (the server 20 may not be provided). In this instance, a transaction is Peer to Peer (P2P between the user UA, UB with respect to rewards to the user UA and payments by the user UB.

The embodiment disclosed herein should be considered to be exemplary and not restrictive in all respects. It is intended that the scope of the disclosure be defined by the appended claims rather than the foregoing description, and that all changes within the meaning and range of equivalency of the claims be embraced therein.

What is claimed is:

1. A power processing system comprising:
a communication unit configured to communicate with both a first facility in which a renewable energy power generation device is installed and a terminal device of a user of a second facility that is different from the first facility; and
a processing unit,
wherein the processing unit determines first power consumption that is electric energy consumed in the first facility during a predetermined aggregation period of a power generation amount of renewable energy power generated by the renewable energy power generation device during the aggregation period,
wherein the processing unit determines second power consumption that is electric energy consumed in a power consumption event implemented in the second facility, using normal power that is different from the renewable energy power,
wherein when the communication unit receives an allocation request from the terminal device, the processing unit executes a certificate issuance process,
wherein the allocation request is a signal that requests allocation of at least a portion of an environmental value of the first power consumption to at least a portion of the second power consumption, and
wherein the certificate issuance process is to issue a certificate certifying that at least a portion of the environmental value is allocated to at least a portion of the second power consumption.

2. The power processing system according to claim 1, wherein:
the processing unit executes a first classification process of classifying the renewable energy power into a first group or a second group in accordance with lifecycle CO2 emissions expressed as CO2 emissions per unit of the renewable energy power in which CO2 emissions in a series of processes including manufacturing, operation and disposal of the renewable energy power generation device;
when the renewable energy power is classified into the first group, the lifecycle CO2 emissions are smaller as compared with when the renewable energy power is classified into the second group;
the processing unit executes a value setting process that sets up the environmental value in accordance with a result of the first classification process; and
the value setting process is to set the environmental value higher when the renewable energy power is classified into the first group as compared with when the renewable energy power is classified into the second group.

3. The power processing system according to claim 1, wherein:
the renewable energy power generation device is a photovoltaic power generation device;
the communication unit acquires weather information indicating weather in an area where the first facility is located;
the processing unit determines a photovoltaic power generation amount that is a power generation amount of the renewable energy power generated by the photovoltaic power generation device;
the processing unit determines whether the photovoltaic power generation amount is within an assumed range of the photovoltaic power generation amount in accordance with the photovoltaic power generation amount and the weather information; and
the processing unit reduces the environmental value when the photovoltaic power generation amount is outside the assumed range as compared with when the photovoltaic power generation amount is within the assumed range.

4. The power processing system according to claim 1, further comprising a storage unit that stores a history of CO2 emissions from the second facility, wherein:
the processing unit executes a second classification process that classifies the second facility into a first facility group or a second facility group in accordance with the history;
when the second facility is classified into the first facility group, the CO2 emissions in the history are smaller as compared with when the second facility is classified into the second facility group;
the processing unit executes the certificate issuance process in accordance with a result of the second classification process; and
the certificate issuance process is to issue the certificate preferentially when the second facility is classified into the first facility group, as compared with when the second facility is classified into the second facility group.

5. The power processing system according to claim 4, wherein:
the power consumption event includes external charging of an electrified vehicle of the user of the second facility;
the external charging is charging of a power storage device of the electrified vehicle using power supplied from power equipment that is external to the electrified vehicle and that is provided in the second facility;
the communication unit acquires event information indicating whether the power consumption event is the external charging;
the processing unit executes the certificate issuance process in accordance with the event information; and
the certificate issuance process is to issue the certificate preferentially when the power consumption event is the external charging, as compared with when the power consumption event is not the external charging.

6. The power processing system according to claim 5, wherein the certificate issuance process includes issuing the certificate only when the power consumption event is the external charging.
